(19) United States
(12) Patent Application Publication
(10) Pub. No.: US 2007/0057096 A1
(43) Pub. Date: Mar. 15, 2007

(54) Gas valve

(76) Inventors: Peter Steinruck, Hallstatt (AT); Martin Geh, Wien (AT); Gerhard Ranegger, Wien (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/519,124

(22) Filed: Sep. 12, 2006

(30) Foreign Application Priority Data
Sep. 14, 2005 (AT) A 1517/2005

(51) Int. Cl. F02M 51/00; B05B 1/30

(52) U.S. Cl. 239/585.1

(57) ABSTRACT

Large opening cross-sections, long switching strokes and short switching periods are of significance in gas valves for feeding gaseous fuel into the combustion chamber of a reciprocating internal combustion engine and to enable injection of the required quantity of gas into the combustion chamber within the very short available time. An additional means is provided to at least temporarily create additional forces biasing the closing member independent from the forces acting upon the closing member whereby the existing force relationship between the closing spring and the opening solenoid can be especially influenced.

### BACKGROUND OF THE INVENTION

1. Field of the Invention

The present invention relates to a gas valve for feeding gaseous fuel into the combustion chamber of a reciprocating internal combustion engine including a movable closing member which cooperates with a seat of the closing element and which can be lifted from the seat to open by means of a solenoid, and including a closing spring exerting a resilient force in the direction of the seat of the closing element whereby the existing gas pressure exerts a gas force in the direction of the seat onto the closing member as well. The invention also relates to a method of actuating a gas valve of the aforementioned type.

2. The Prior Art

Gas valves require large opening cross-sections to feed gaseous fuel into the combustion chamber of an internal combustion engine to be able to inject sufficient gaseous fuel into the cylinder chamber within the brief available open periods. Such gas valves are often times opened by means of solenoids whereby the solenoid must perform a sufficiently large stroke to feed the necessary quantities of gas within the brief opening periods. To this end, the shortest opening and closing periods are desired so that the time in which the gas valve is fully open in the crank cycle is of the longest duration possible. Since the magnetic force decreases rapidly during increase in the gap between the armature and the solenoid, such solenoids must be either be very strong or the cross-section of the opening must be correspondingly large. However, in case of the desired small strokes (to be able to keep the opening and closing periods as brief as possible), the possibly available gas quantity is essentially determined by the size of the stroke.

Gaseous fuel is fed into the combustion chamber of the reciprocating internal combustion engine only one time during a crank cycle of the engine whereby said crank cycle is 720 degrees expressed in the rotational travel of the crank shaft. In the rule, only very short periods are available for this purpose and the gas valve has to open and close very rapidly therefore and it must have a sufficient flow cross-section to be able to supply the required quantity of gas in the available timeframe. Only crank angles of 10 degrees are typically available out of the entire crank cycle to supply the gaseous fuel. Within this injection time, the gas valve has to be opened, the gaseous fuel has to be fed into the combustion chamber, and the gas valve has to be closed again. Only a few milliseconds are available for this purpose depending on the rotational speed, typically 1-4 milliseconds. The gas valve must thus be able to switch very rapidly and it must have a large opening cross-section to be able to supply sufficient gaseous fuel within this short period.

Known from prior art are gas valves that open to the inside—in other words, the opening leads into the gas valve or leads out of the combustion chamber as disclosed in DE 199 05 722 A1, for example. These gas valves open up thereby against the existing gas pressure of the gaseous fuel and they have to sealingly close against the pressure existing in the combustion chamber. Since the pressure in the combustion chamber is greater than the gas pressure existing essentially only during the combustion phase, the closing member is pressed against the valve seat by the gas pressure during the largest part of the crank cycle. An existing closing spring works only in a supporting role during this period. A closing spring is only required during the combustion in the combustion chamber whereby said closing spring presses the closing member on the valve seat against the high pressure in the combustion chamber developing during the combustion to keep the valve closed during this high combustion chamber pressure. The closing member can thereby be deformed in the range of a few micrometers whereby combustion gases can escape from the combustion chamber, which is, however, not a problem in the combustion process itself. The spring must therefore be strong enough to keep the closing member on the valve seat against the differential pressure and to ensure the most rapid closing of the valve after the solenoid is switched off. In return, this is again a disadvantage relative to the opening of the valve since the opening solenoid must work against the great force of the spring, which extends the opening periods, on the one hand, and which requires a strong solenoid, on the other hand. However, the force of the solenoid is limited by the available space since a solenoid becomes larger in size corresponding to increased power requirements. Besides, a strong solenoid requires too much electric power so that such a fuel injector would become uneconomical.

Additional examples of such gas valves opening to the inside are disclosed in DE 103 60 253 A1 and DE 102 61 610 A1, for example, both examples show therein a valve to control a fluid whereby a valve closing member is moved axially across a valve armature in the opening process against the initial tension of a spiral spring whereby said valve armature is actuated by means of a solenoid.

Gas valves opening to the outside into the combustion chamber have been proposed to eliminate this problem as disclosed in AT 412 807 B, for example. Such gas valves open to the outside and seal against the existing gas pressure. A closing member is pressed against the valve seat from the outside by means of a closing spring and by means of a plunger that extends through the valve seat. The closing member is here pressed against the valve seat with the aid of the pressure in the combustion chamber, whereby at least the above-mentioned problem is eliminated. However, it must be ensured that the large closing member required to cover the large opening cross-sections is not deformed by the gas pressure existing at the closed valve over the largest part of the crank cycle, as described, since in case of any deformation gaseous fuel not needed for combustion can enter the combustion chamber which would change the emission values as an unused discharge. Gaps in the range of a few micrometers would be already enough to cause this discharge. The closing member would have to be designed very sturdy and/or the closing spring would have to be designed to be very strong again, which is a disadvantage once more because of the large solenoid required for opening.

It is therefore the object of the present invention to provide a gas valve which eliminates the above-mentioned disadvantages, which is designed in a compact manner, which can be operated economically and which makes possible high dynamics at large opening strokes, which means brief opening and closing periods.

### SUMMARY OF THE INVENTION

This object is achieved according to the invention in that additional means are provided for at least a temporary creation of an additional force biasing the closing member independently from the other effective forces. It is made possible thereby to influence the movement of the closing member through these means actively and independently, or additionally, relative to the balance of effectiveness of the closing spring and the opening solenoid. For example, the closing spring can be designed smaller, on the one hand, and it can be closed more rapidly, on the other hand. Or, an additional force can encounter the opening force of the opening solenoid which would slow down the opening process and which would therefore make the control of the opening process or the control of the gas injection possible. In reverse, the same would naturally be possible for the closing process.

Pneumatic, hydraulic or electromechanical means are used especially advantageous to create this supplemental force. In case of injection valves for liquid fuel, e.g., diesel injection valves, there are valves known from prior art which operate with two solenoids as described in U.S. Pat. No. 6,065,684 A or WO 2004/097207, for example. However, such injection valves operate with a fluid medium under very high pressures, typically in the range of 100 bar, while the gas valves of the invention are operated with pressures in the range of approximately 10-40 bar. Small opening cross-sections and small strokes are sufficient in injection valves based on the high pressures and the low quantity of fluid, especially in case of the pre-injection performed in diesel engines. Moreover, only extremely short switching times are required for such injection valves which are made possible through the described control of the solenoids. Problems occurring in a gas valve play therefore no role at all in such injection valves.

Such means are used especially advantageously to supplement the closing process in that the force acting upon the closing member created by said means is effective in the direction of the seat of the closing element. The aforementioned disadvantages of a single closing spring can be very effectively eliminated thereby.

The present invention will now be described with the aid of the attached drawings.

### BRIEF DESCRIPTION OF THE DRAWINGS

FIG. 1 schematically shows a gas valve according to a preferred embodiment of the invention having two armature plates and two solenoids;

FIG. 2 schematically shows a gas valve according to another preferred embodiment of the invention having one armature plate and two solenoids; and

FIG. 3 shows the arrangement of such a gas valve in a reciprocating internal combustion engine.

### DETAILED DESCRIPTION OF THE PREFERRED EMBODIMENTS

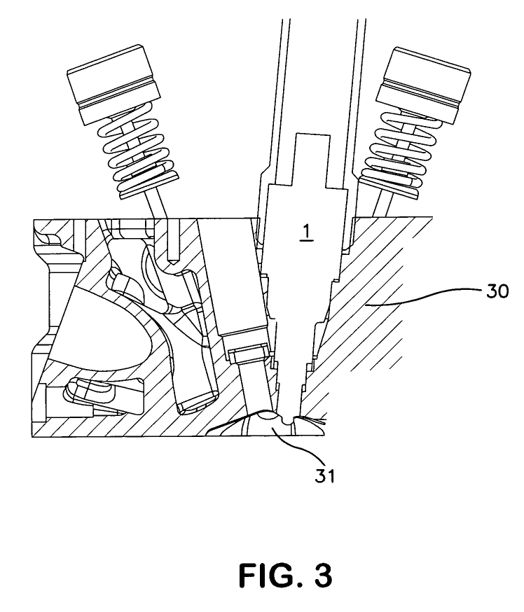

A gas valve 1 according to the invention is arranged in a reciprocating internal combustion engine 30 and serves for the supply of gaseous fuel into the combustion chamber 31 of the reciprocating internal combustion engine 30, as illustrated in FIG. 3. FIG. 3 shows thereby for reasons of simplicity only one section of the reciprocating internal combustion engine 30 together with the combustion chamber 31.

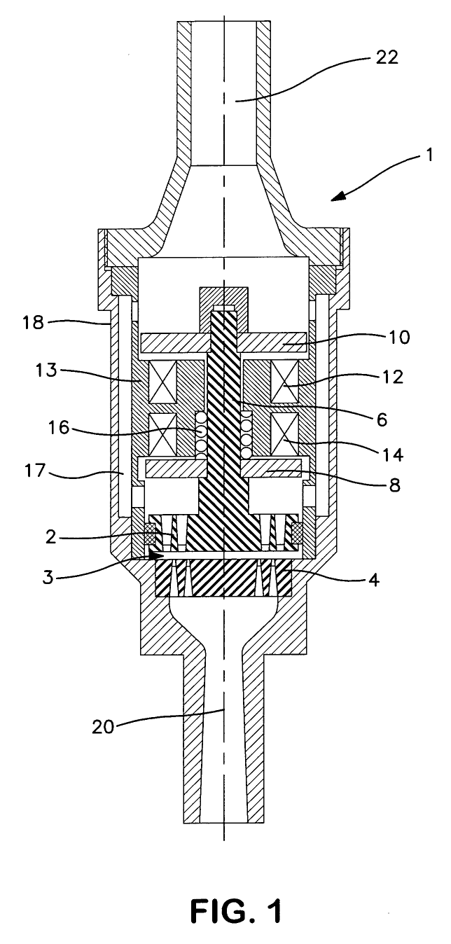

The gas valve 1 of a reciprocating internal combustion engine 30 in FIG. 1 has a valve body 18 whereby the nozzle 20 is attached onto the lower end thereof and which cooperates with the combustion chamber 31 of the reciprocating internal combustion engine 30 (not illustrated) in the supply of gaseous fuel, e.g. liquid gas, hydrogen or a suitable gas mixture. A device to close the gas valve is disposed at the upper end of the gas valve 1 serving as a seal and for the supply of electric power etc. which is generally known from prior art and is without further significance for the present invention and which is therefore not described in more detail. The arrangement of such a gas valve 1 in a reciprocating internal combustion engine 30 and the control of such a gas valve 1 is known from prior art and is also not described here in more detail. In the present embodiment version, the gaseous fuel is fed into the gas valve 1 through a gas supply passage 22 at the upper end of the valve body 18, typically under pressure of 10-40 bar, and said gaseous fuel flows through a supply passage 17, formed axially on the outside of the valve body, and flows along the magnetized body 13 arranged in the gas valve 1 and downward to the actual valve 3. This valve 3 consists of a closing member, in this case an essentially flat valve plate 2, which cooperates here with an essentially flat valve seat 4. The valve plate 2 is provided in a known manner with a row of openings to make available the largest flow cross-section possible for the gaseous fuel. The valve seat 4 is also provided with openings which are arranged correspondingly offset relative to the openings of the valve plate 2 to cause a sealing effect upon contact by the valve plate 2 with the valve seat 4. The valve plate 2 is connected for this purpose to a plunger 6 and can be moved with the same.

Additional parts of the gas valve, such as connections, electric power supply for the solenoids, seals, control devices, etc., are known from prior art and are therefore not described here in more detail.

The plunger 6 is guided within the magnetized body 13. Armature plates 8, 10 are arranged on each end of the plunger 6 cooperating with a solenoid 12, 14 arranged thereto, preferably a pot-shaped solenoid. The resilient force of a closing spring 16 additionally acts upon the plunger 6 or the valve plate 2 whereby the closing spring is also arranged within the magnetized body 13. The closing spring 16 is arranged for this purpose in a recess of the magnetized body 13 and is supported by the armature plate 8 or by a collar, or by another suitable structural part of the plunger 6.

The gas valve 1 is opened during a crank cycle, which corresponds in the rule to a crank angle of 720 degrees. Gaseous fuel is injected into the combustion chamber while the gas valve 1 is open and subsequently the gas valve 1 is closed and kept closed until the next injection process. The injection phase is thereby generally very short relative to the crank cycle, approximately a crank angle of 10 degrees or a few milliseconds. The gas valve 1 is thereby closed during the longest period of the crank cycle.

The opening solenoid 14 is energized to open the gas valve 1 whereby the opening armature 8 and therefore the plunger 6 are pulled up and the valve plate 2 is lifted. The opening process is performed against the gas pressure biasing the valve plate 2 and against the spring force of the closing spring 16. The opening solenoid 14 must be strong enough thereby to overcome these forces and still open the gas valve 1 with sufficient speed. Gaseous fuel flows through the valve 3 as soon as the gas valve 1 opens and it subsequently flows through the nozzle 20 into the combustion chamber 31 (not illustrated).

The opening solenoid 14 is switched off to close the gas valve 1. The tension of the closing spring 16 is released thereby which has the result that the plunger 6 together with the valve plate 2 move in the direction of the valve seat 4. The closing solenoid 12 is energized to supplement the force of the closing spring 16 whereby the closing armature 10 is pulled up and whereby an additional magnetic force becomes effective in the direction of the valve seat 4. The closing spring 16 can thereby be sized to be weaker and a shorter closing period can be realized thereby at the same time.

The pressure in the combustion chamber is lower than the gas pressure except during the time of ignition and combustion. The closing solenoid 12 can be switched off again after the closing of the valve 3 since the force of the closing spring 16 together with the gas pressure biasing the valve plate 2 is sufficient to keep the valve 3 closed against the pressure in the combustion chamber. The closing magnet 12 is again energized to supplement the force of the closing spring 16 during the combustion phase (which means when the combustion pressure in the combustion chamber is greater than the gas pressure) and to keep the valve 3 securely closed thereby. The closing spring 16 can again be sized to be weaker. Since the closing solenoid 12 does not have to be energized continuously, electric energy can be saved whereby such a gas valve 1 can also be operated more economically.

Of course, a great variety of control methods are possible for the two solenoids 12, 14 as known from prior art. For example, both solenoids 12, 14 can be temporarily energized at the same time to achieve a type of a pre-tensioning and thereby faster switching periods are achieved whereby the full magnetic force is fully built-up at the desired switching time. It would also be possible to catch the valve plate 2 partly during the switching process, e.g. during the opening process, by energizing the solenoid having a power that is effective in opposite direction and whereby it would be possible to open the valve 3 only partially. For example, the quantity of the gaseous fuel to be injected could be changed more precisely in this manner.

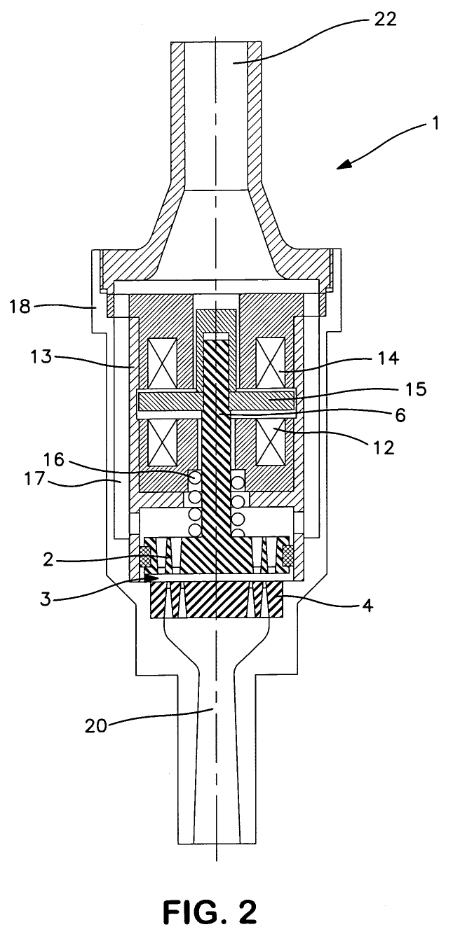

FIG. 2 shows an alternative embodiment of the gas valve 1 of the invention having only one armature plate 15 arranged between two solenoids 12, 14. The function is essentially the same as the one in the embodiment according to FIG. 1 so that this function does not have to be described anew.

In addition, the valve plate 2 and the plunger 6 are here designed as one piece. The armature plate 15 is arranged at the end of the plunger 6 that is facing away from the valve plate 2 whereby said armature plate 15 is alternatively pulled up by one of the two solenoids 12, 14. As already described above, both solenoids 12, 14 can be simultaneously energized for specific types of operation, of course.

Even though the invention is described with the aid of embodiments comprising two solenoids, it would also be possible to provide here pneumatic or hydraulic actuation, of course, to close the valve in place of the second solenoid 12 or supplemental thereto. For example, one or several pneumatic or hydraulic pistons would act upon the valve plate 2 directly or indirectly through the plunger 6 to produce a supplemental force to move the valve plate 2. The pneumatic or hydraulic cylinder would be supplied with a suitable pressure medium known from prior art and controlled by means of known pneumatic or hydraulic valves.

Conceivable would be also other principally known means to produce a force, e.g., electromechanical actuators, such as inductive actuators or piezo-electric actuators

The constructive arrangement of such means to produce a force in the gas valve 1, analogous to the arrangement of a second solenoid, lies in the range of the normal activity of those skilled in the art and is therefore not further discussed.

1. A gas valve for feeding gaseous fuel into the combustion chamber (31) of a reciprocating internal combustion engine (30) comprising a movable closing member (2) which cooperates with a seat (4) of the closing element and which can be lifted from the seat (4) to open up by means of a solenoid (14), a closing spring (16) exerting a resilient force in the direction of said seat (4) onto the closing member (2), whereby the existing gas pressure exerts a force in the direction of said seat (4) upon the closing member (2) as well, and additional means for at least a temporary creation of a supplemental force biasing the closing member independently from the other effective forces.

2. A gas valve according to claim 1, including a pneumatic or hydraulic actuated piston as closing means which act upon the closing member (2).

3. A gas valve according to claim 1, including electromechanical means as closing means, such as an additional solenoid (12), a piezo-electric element or an inductive element and whose force in its energized condition biases the closing member (2).

4. A gas valve according to claim 1, wherein the additional means create a force to bias the closing member (2) in the direction of the seat (4) of the closing element.

5. A method to actuate a gas valve for feeding gaseous fuel into a combustion chamber (31) of a reciprocating internal combustion engine (30) whereby the gas valve (1) is opened, is kept open, is closed and is kept closed during one crank cycle in that a closing member (2) is moved against a closing spring (16) by a solenoid (14) which opens said valve against the gas pressure, including the step of creating an additional force on the closing member at least temporarily during the crank cycle whereby said additional force is independent from the other forces biasing the closing member (2).

6. A method according to claim 5 whereby said additional force is created periodically relative to the crank cycle.
